(19) United States
(12) Patent Application Publication
(10) Pub. No.: US 2026/0245267 A1
(43) Pub. Date: Aug. 20, 2026

(54) Enhancing Color Correction Using Images from Multiple Electronic Devices

(71) Applicant: Apple Inc., Cupertino, CA (US)

(72) Inventors: Sivalogeswaran Ratnasingam, Fremont, CA (US); Anshul K. Jain, Sunnyvale, CA (US); Anselm Grundhoefer, Campbell, CA (US)

(21) Appl. No.: 19/392,613

(22) Filed: Nov. 18, 2025

Related U.S. Application Data
(60) Provisional application No. 63/759,937, filed on Feb. 18, 2025.

(51) Int. Cl. G06T 11/10; H04N 23/66; H04R 1/02; H04R 1/10

(52) U.S. Cl. CPC G06T 11/10; H04N 23/66; H04R 1/028; H04R 1/10

(57) ABSTRACT

A method of operating a head-mounted device is provided that includes gathering sensor data, predicting a pose of the head-mounted device based on the gathered sensor data, directing a first device external to the head-mounted device to capture a first image in response to determining that the predicted pose is facing a first direction, and directing a second device external to the head-mounted device to capture a second image in response to determining that the predicted pose is facing a second direction different than the first direction. The method can further include performing color correction of augmented reality (AR) content based on the first or second image. The color corrected AR content can be presented on a see-through display of the head-mounted device. The method can further include determining a location of the head-mounted device based images wirelessly received from one or more non-wearable devices.

This application claims the benefit of U.S. Provisional Patent Application No. 63/759,937, filed February 18, 2025, which is hereby incorporated by reference herein in its entirety.

### FIELD

This disclosure relates generally to electronic devices and, more particularly, to electronic devices with transparent displays.

### BACKGROUND

Some electronic devices include transparent displays that present images close to a user’s eyes. The transparent displays permit viewing of a user’s physical environment through the transparent display. For example, extended reality headsets may include transparent displays. Such electronic devices with transparent displays can include cameras for capturing an image of the surrounding environment. It is within this context that the embodiments herein arise.

### SUMMARY

An aspect of the disclosure provides a method of operating a head-mounted device that includes gathering sensor data, predicting a pose of the head-mounted device based on the gathered sensor data, directing a first device external to the head-mounted device to capture a first image in response to determining that the predicted pose of the head-mounted device is facing a first direction, and directing a second device external to the head-mounted device to capture a second image in response to determining that the predicted pose of the head-mounted device is facing a second direction different than the first direction. The first device can be a left earbud device having one or more cameras configured to capture the first image. The second device can be a right earbud device having one or more cameras configured to capture the second image or a wristwatch device having one or more cameras configured to capture the second image. The method can further include wirelessly receiving the first image from the first device, color correcting augmented reality (AR) content based on the first image wirelessly received from the first device to produce corresponding color corrected content, and presenting, on a transparent display of the head-mounted device, the color corrected content.

An aspect of the disclosure provides a method of operating a head-mounted device that includes acquiring a plurality of images of a scene, obtaining a panoramic image by stitching together the plurality of images or constructing a three-dimensional model of the scene based on the plurality of images, estimating or predicting a pose of the head-mounted device, color correcting augment reality (AR) content based on the panoramic image or the three-dimensional model of the scene and based on the pose of the head-mounted device to produce corresponding color corrected content, and presenting, on a transparent display of the head-mounted device, the color corrected content. The method can further include extracting a region of interest from the panoramic image or from the three-dimensional model of the scene based on the estimated or predicted pose of the head-mounted device, where color correcting the AR content includes color correcting the AR content based on the extracted region of interest. The method can further include computing a plurality of color corrected images corresponding to different portions of the panoramic image, where color correcting the AR content comprises color correcting the AR content based on a selected one of the plurality of color correct images corresponding to the estimated or predicted pose of the head-mounted device.

An aspect of the disclosure provides a method of operating a head-mounted device that includes capturing an image with a camera, predicting a pose of the head-mounted device, reading out or extracting only a subset of the image based on the predicted pose of the head-mounted device, color correcting augment reality (AR) content based on the subset of the image to produce corresponding color corrected content, and presenting, on a transparent display of the head-mounted device, the color corrected content. The camera can include more than three color filters for capturing multispectral data that is used to create a 3-dimensional reflectance map of a physical environment in which the head-mounted device is operated. The head-mounted device can be associated with a first user. The method can further include wirelessly receiving an image from an external device that is associated with a second user different than the first user and determining a location of the head-mounted device based on the image wirelessly received from the external device.

### BRIEF DESCRIPTION OF THE DRAWINGS

FIG. 1 is a diagram of an illustrative system having a transparent display in accordance with some embodiments.

FIG. 2 is a diagram of an illustrative augmented reality (AR) content that can be displayed over a physical environment in accordance with some embodiments.

FIG. 3 is a diagram of an illustrative color correction subsystem configured to perform color correction based on at least first and second superposition values in accordance with some embodiments.

FIG. 4 is a diagram showing how multiple electronic devices mounted on a user can be configured to capture images for color correction in accordance with some embodiments.

FIG. 5 is a flowchart of illustrative steps for operating electronic devices of the types shown in FIG. 4 in accordance with some embodiments.

FIG. 6 is a flowchart of illustrative steps for performing color correction based on a stitched panoramic image in accordance with some embodiments.

FIG. 7 is a flowchart of illustrative steps for performing color correction based on a three-dimensional reconstruction of a scene in accordance with some embodiments.

FIG. 8 is a flowchart of illustrative steps for precomputing color corrected images in accordance with some embodiments.

FIG. 9 is a flowchart of illustrative steps for performing color correction based on a portion of a wide-angle image in accordance with some embodiments.

FIG. 10 is a diagram showing how multiple electronic devices mounted on a user and within a controlled environment can be configured to capture images for color correction in accordance with some embodiments.

### DETAILED DESCRIPTION

A physical environment can refer to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell.

In contrast, an extended reality (XR) environment refers to a wholly or partially simulated environment that people sense and/or interact with via an electronic device. For example, an XR environment may include augmented reality (AR) content, mixed reality (MR) content, virtual reality (VR) content, and/or the like. With an XR system, a subset of a person’s physical motions, or representations thereof, are tracked, and, in response, one or more characteristics of one or more virtual objects simulated in the XR environment are adjusted in a manner that comports with at least one law of physics.

As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment.

Rather than an opaque display, a head mountable system may have a transparent or translucent display. The transparent or translucent display may have a medium through which light representative of images is directed to a person’s eyes. The display may utilize digital light projection, organic light-emitting diodes (OLEDs), LEDs, micro light-emitting diodes (uLEDs), liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to selectively become opaque. Projection-based systems may employ retinal projection technology that projects graphical images onto a person’s retina. Projection systems also may be configured to project virtual objects into the physical environment, for example, as a hologram or on a physical surface.

Head-mounted devices may display different types of extended reality content for a user. The head-mounted device may display a virtual object, sometimes referred to herein as virtual content, that is perceived at an apparent depth within the physical environment of the user. Virtual objects may sometimes be displayed at fixed locations relative to the physical environment of the user. For example, consider an example where a user’s physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as “world-locked” content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user’s head), the virtual object remains in a fixed position relative to the head-mounted device. For example, the virtual object may be displayed in the front and center of the head-mounted device (e.g., in the center of the device’s or user’s field of view) at a particular distance. As the user moves their head left and right, their view of their physical environment changes accordingly. However, the virtual object may remain fixed in the center of the device’s or user’s field of view at the particular distance as the user moves their head (assuming gaze direction remains constant). This type of content may be referred to as “head-locked” content. The head-locked content is fixed in a given position relative to the head-mounted device (and therefore the user’s head which is supporting the head-mounted device). The head-locked content may not be adjusted based on a user’s gaze direction. In other words, if the user’s head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user’s torso). This type of content may be referred to as “body-locked” content. For example, a virtual object may be displayed in front and to the left of a user’s body (e.g., at a location defined by a distance and an angular offset from a forward-facing direction of the user’s torso), regardless of which direction the user’s head is facing. If the user’s body is facing a first direction, the virtual object will be displayed in front and to the left of the user’s body. While facing the first direction, the virtual object may remain at the same, fixed position relative to the user’s body in the XR environment despite the user rotating their head left and right (to look towards and away from the virtual object). However, the virtual object may move within the device’s or user’s field of view in response to the user rotating their head. If the user turns around and their body faces a second direction that is the opposite of the first direction, the virtual object will be repositioned within the XR environment such that it is still displayed in front and to the left of the user’s body. While facing the second direction, the virtual object may remain at the same, fixed position relative to the user’s body in the XR environment despite the user rotating their head left and right (to look towards and away from the virtual object).

In the aforementioned example, body-locked content is displayed at a fixed position/orientation relative to the user’s body even as the user’s body rotates. For example, the virtual object may be displayed at a fixed distance in front of the user’s body. If the user is facing north, the virtual object is in front of the user’s body (to the north) by the fixed distance. If the user rotates and is facing south, the virtual object is in front of the user’s body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user’s body at a fixed distance from the user as the user faces north. If the user rotates and is facing south, the virtual object remains to the north of the user’s body at the fixed distance from the user’s body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

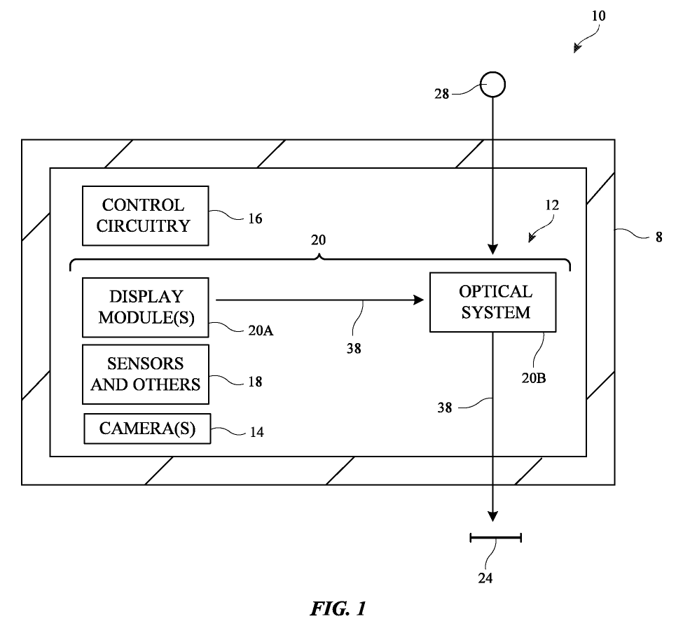

System 10 (sometimes referred to as electronic device 10, head-mounted device 10, etc.) of FIG. 1 may be a head-mounted device having one or more displays. The displays in system 10 may include displays 20 (sometimes referred to as near-eye displays) mounted within support structure (housing) 8. Support structure 8 may have the shape of a pair of eyeglasses or goggles (e.g., supporting frames), may form a housing having a helmet shape, or may have other configurations to help in mounting and securing the components of near-eye displays 20 on the head or near the eye of a user. Near-eye displays 20 may include one or more display modules such as display modules 20A and one or more optical systems such as optical systems 20B. Display modules 20A may be mounted in a support structure such as support structure 8. Each display module 20A may emit light 38 (image light) that is redirected towards a user’s eyes at eye box 24 using an associated one of optical systems 20B. Displays 20 can be transparent or translucent displays and are sometimes referred to as “see-through” displays. Displays 20 are optional and can be omitted from device 10.

The operation of system 10 may be controlled using control circuitry 16. Control circuitry 16 may be configured to perform operations in system 10 using hardware (e.g., dedicated hardware or circuitry), firmware and/or software. Software code for performing operations in system 10 and other data is stored on non-transitory computer readable storage media (e.g., tangible computer readable storage media) in control circuitry 16. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16. The processing circuitry may include application-specific integrated circuits with processing circuitry, one or more microprocessors, digital signal processors, graphics processing units, a central processing unit (CPU) or other processing circuitry.

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include one or more cameras 14 (sometimes referred to as image sensors 14). Cameras 14 may be used for gathering images of physical objects that are optionally digitally merged with virtual objects on a display in system 10. Input-output devices 12 may include sensors and other components 18 (e.g., accelerometers, gyroscopes, depth sensors, light sensors, haptic output devices, speakers, batteries, wireless communications circuits for communicating between system 10 and external electronic equipment, etc.).

Cameras 14 that are mounted on a front face of system 10 and that face outwardly (towards the front of system 10 and away from the user) may sometimes be referred to herein as outward-facing, external-facing, forward-facing, or front-facing cameras. Cameras 14 may capture visual odometry information, image information that is processed to locate objects in the user’s field of view (e.g., so that virtual content can be registered appropriately relative to real-world objects), image content that is displayed in real time for a user of system 10, and/or other suitable image data. For example, outward-facing cameras 14 may allow system 10 to monitor movement of the system 10 relative to the environment surrounding system 10 (e.g., the cameras may be used in forming a visual odometry system or part of a visual inertial odometry system). Outward-facing cameras 14 may also be used to capture images of the environment that are displayed to a user of the system 10. If desired, images from multiple outward-facing cameras 14 may be merged with each other and/or outward-facing camera content can be merged with computer-generated content for a user.

Display modules 20A may be liquid crystal displays, organic light-emitting diode displays, laser-based displays, or displays of other types. Optical systems 20B may form lenses that allow a viewer (see, e.g., a viewer’s eyes at eye box 24) to view images on display(s) 20. There may be two optical systems 20B (e.g., for forming left and right lenses) associated with respective left and right eyes of the user. A single display 20 may produce images for both eyes or a pair of displays 20 may be used to display images. In configurations with multiple displays (e.g., left and right eye displays), the focal length and positions of the lenses formed by system 20B may be selected so that any gap present between the displays will not be visible to a user (e.g., so that the images of the left and right displays overlap or merge seamlessly).

If desired, optical system 20B may contain a transparent structure (e.g., an optical combiner, etc.) that allows image light from physical objects 28 to be combined optically with virtual (computer-generated) images such as virtual images in image light 38. Light from physical objects 28 in the physical environment or scene can sometimes be referred to and defined herein as world light, scene light, ambient light, external light, or environmental light. In this type of system, a user of system 10 may view both the physical environment around the user and computer-generated content that is overlaid on top of the physical environment. Cameras 14 may also be used in device 10 (e.g., in an arrangement in which a camera captures images of physical object 28 and this content is modified and presented as virtual content at optical system 20B).

System 10 may, if desired, include wireless circuitry and/or other circuitry to support communications with a computer or other external equipment (e.g., a computer that supplies display 20 with image content). During operation, control circuitry 16 may supply image content to display 20. The content may be remotely received (e.g., from a computer or other content source coupled to system 10) and/or may be generated by control circuitry 16 (e.g., text, other computer-generated content, etc.). The content that is supplied to display 20 by control circuitry 16 may be viewed by a viewer at eye box 24.

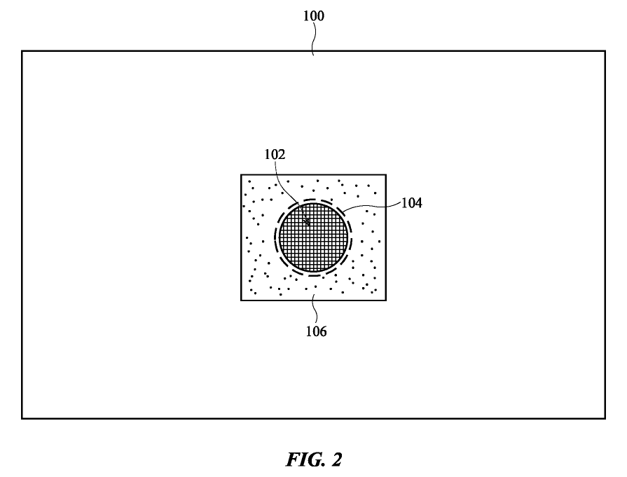

FIG. 2 is a diagram of an illustrative augmented reality (AR) content that can be displayed over a physical environment in accordance with some embodiments. As shown in FIG. 2, virtual content 102 can be presented within a display area 100 of the see-through display system 20. Virtual content 102, illustrated by a cross-hatched pattern in FIG. 2, can include a virtual image having a plurality of pixel values (e.g., red, green, and blue or “RGB” values). The plurality of pixel values may be associated with a plurality of color characteristics vectors. For example, a particular pixel value can be characterized by a corresponding color characteristic vector, which includes a combination of a hue value, a saturation value, a chrome value, a luminance value, or other color-related values.

The virtual content 102 is displayed over a background region 104 within the see-through display area 100. The background region 104, as illustrated by the region surrounded by the dotted line in FIG. 2, coincides with a position at which virtual content 102 is displayed (e.g., background region 104 corresponds to a background region relative to the virtual image). Background region 104 may represent a portion of the real-world (physical) scene directly behind the virtual content 102. As such, virtual content 102 being directly overlaid on top of the portion of the real-world scene can sometimes be referred to herein as augmented reality (AR) content, an AR image, or simply as an augmentation. The background region 104 may be encompassed by an associated surrounding region 106, shown in FIG. 2 by a stipple pattern (e.g., surrounding region 106 corresponds to a region that surrounds the background region 104).

In practice, ambient light (e.g., environmental light from the physical scene in which device 10 is being operated) incident on the see-through display may adversely affect the color of virtual content 102 being presented on the see-through display. For instance, the perceived color of AR content presented on the see-through display may depend on the lux level of the ambient light, chromaticity of the ambient light, the background color (e.g., the color of background region 104), and the surrounding color (e.g., the color of surrounding region 106). Accordingly, device 10 can be configured to perform color correction based on some function of one or more characteristics associated with the ambient light.

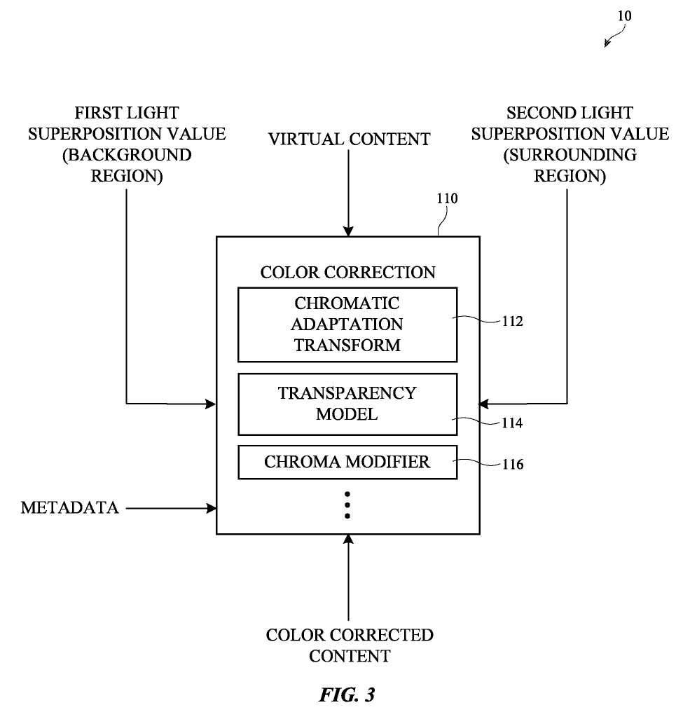

For example, as shown in FIG. 3, device 10 can include a color correction subsystem such as color correction circuit 110 configured to perform color correction based on at least first and second light superposition values. Color correction subsystem 110 can receive virtual content and perform color correction on the virtual content based on a first light superposition value quantifying an amount of the ambient light incident on a first region of the see-through display (e.g., a first light superposition value associated with a background region 104 directly behind the virtual content), a second light superposition value quantifying an amount of the ambient light incident on a second region of the see-through display (e.g., a second light superposition value associated with a region 106 surrounding virtual content 102 and background region 104), and optionally metadata. Subsystem 110 may be configured to implement a color correction function based on a combination of the first light superposition value (sometimes referred to as the background region light value), the second light superposition value (sometimes referred to as the surrounding region light value), and the associated metadata.

Color correction subsystem 110 may be configured to perform one or more color correction functions based on a chromatic adaptation transform 112, a transparency model 114, a chroma modifier 116, and/or other color correction algorithms. Chromatic adaptation transform (CAT) 112 may account for (e.g., represent or simulate) a visual system’s ability to adjust to changes in illumination in order to preserve the appearance of an object’s colors, sometimes referred to as “color constancy.” For example, color correction subsystem 110 may detect a change to the received light superposition values and then color correct the virtual content to produce corresponding color corrected content. The color corrected content, which when displayed with the incident ambient light on the see-through display, satisfies a color constancy threshold specified by CAT 112. In some implementations, CAT 112 includes a combination of linear and non-linear components. For example, CAT 112 can be based on a Von Kries chromatic adaptation, Retinex theory, Nayantani model, or MacAdam’s model, just to name a few. In other implementations, CAT 112 can be based on a color appearance model, which provides perceptual aspects of human color vision, such as the extent to which viewing conditions of a color diverge from the corresponding physical measurement of the stimulus source.

Since virtual (AR) content 102 is displayed directly over background region 104 in the see-through display, virtual content 102 represents a transparent image that is superimposed over a (background) portion of the physical scene. Transparency model 114 can model a visual system’s perception of a transparent image based on a function of the received light superposition values. For example, color correction subsystem 110 can be configured to determine a perceived color of the transparent image by applying transparency model 114 to the light superposition values and the transparent image. Color correction subsystem 110 can correct the transparent image based on a function of the perceived color of the transparent image. For example, color correction subsystem 110 can modify a hue, chroma, or saturation associated with the transparent image in order to offset the perceived color of the transparent image. As an example, transparency model 114 may perform a weighted sum of different color characteristics of the ambient light and the transparent image. As another example, transparency model 114 may be a filter-based model that accounts for additive color mixing and subtractive color mixing. As another example, transparency model 114 may be based on the first light superposition value associated with a background (e.g., background region 106 of FIG. 2). The first light superposition value can indicate a luminance of the ambient light, and transparency model 114 can indicate a reduction in the perceived chroma or saturation of the transparent image based on a function of the luminance. Additionally or alternatively, transparency model 114 may also be based on the second light superposition value associated with a surrounding region (e.g., surrounding region 106 in FIG. 2).

Chroma modifier 116 can be configured to correct the transparent image by modifying (e.g., boosting or reducing) a chroma value of the transparent image to be displayed. Chroma modifier 116 can determine a chroma value based on the light superposition values (e.g., the first light superposition value associated with background region 104 and/or the second light superposition value associated with surrounding region 106) and a color characteristic vector associated with the transparent image. For example, the light superposition values may indicate a luminance (e.g., brightness) characteristic associated with the ambient light. As another example, the color characteristic vector can include a combination of a chroma value and a hue value associated with the image. Accordingly, the color corrected content, which when displayed with the incident ambient light on the see-through display, can appear more vivid relative to the uncorrected virtual content.

In some embodiments, color correction subsystem 110 can further color correct the virtual content based on metadata associated with the virtual content. The metadata can indicate a use case or user preference. As one example, the user preference can indicate a user’s desired brightness level or color composition. As another example, the metadata can be indicative of an application type associated with the virtual content. As yet another example, the metadata can be indicative of an object type (e.g., a living object versus an inanimate object) represented by the virtual content, an object of interest (e.g., popular object or avatar) represented by the virtual content, etc. The metadata can also include a color correction matrix, a degree of transparency, a chroma enhancement (boost) coefficient, and/or other color correction metadata. If desired, other types of metadata can be provided to color correction subsystem 110.

In certain embodiments, virtual or AR content presented on the see-through display(s) of head-mounted device 10 can be displayed as head-locked content or body-locked content. Whether the AR content is displayed as head-locked content or body-locked content, proper color correction of the AR content requires capturing images at a sufficient frame rate, image resolution, and color accuracy. In practice, a user operating head-mounted device 10 tends to move his/her head by turning left (e.g., from right to left about a yaw axis) or turning right (e.g., from left to right about the yaw axis). In accordance with some embodiments, image sensor(s) or camera(s) in additional external devices such as associated accessory devices can be used to proactively capture one or more images based on a predictive head pose estimation model to help improve color correction of the AR content.

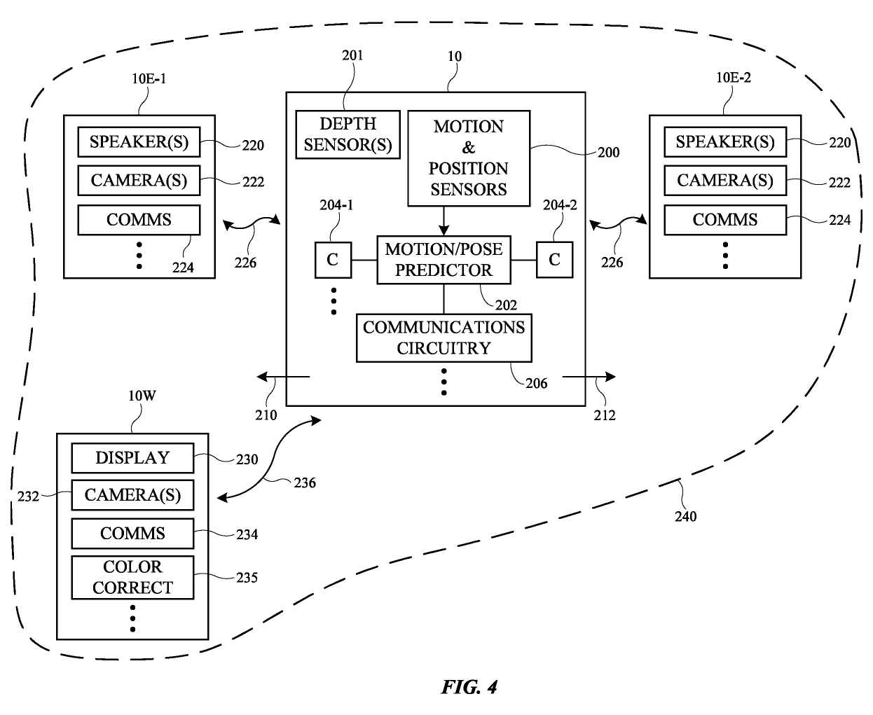

FIG. 4 is a diagram showing how multiple electronic devices mounted on a user can be configured to capture images for color correction. As shown in FIG. 4, device 10 may represent a head-mounted device of the type described in connection with FIGS. 1-3. Device 10 may include one or more sensors such as motion and position sensors 200 and depth sensor(s) 201, motion and/or pose predicting subsystem such as motion/pose predictor 202, image sensors such as cameras 204-1 and 204-2, and communications circuitry 206. Cameras 204-1 and 204-2 may represent outward-facing cameras configured to capture different portions of the physical environment. For example, camera 204-1 may be a first outward-facing camera pointed or biased towards a first direction (e.g., to the left of device 10, as indicated by arrow 210), whereas camera 204-2 may be a second outward-facing camera pointed or biased towards a second direction (e.g. to the right of device 10, as indicated by arrow 212). Camera 204-1 may thus sometimes be referred to as a leftward-facing image sensor, whereas camera 204-2 can sometimes be referred to as a rightward-facing image sensor.

Motion and position sensors 200 may be part of a visual-inertial odometry (VIO) subsystem that combines visual data from one or more cameras (e.g., outward-facing cameras 204-1 and 204-2 and/or other cameras) and inertial data from an inertial measurement unit or IMU (e.g., including one or more gyroscopes, gyrocompasses, accelerometers, magnetometers, other inertial sensors, etc.) to estimate the motion of device 10. Additionally or alternatively, sensors 200 can be part of a simultaneous localization and mapping (SLAM) subsystem that combines the visual information from the one or more cameras and the data from the IMU to construct a two-dimensional (2D) or three-dimensional (3D) map of the physical environment while simultaneously tracking the location and/or orientation of device 10 within that environment. Configured in this way, sensors 200 can sometimes be referred to as a “VIO/SLAM” block or a motion and location determination subsystem and can be configured to output motion information, pose/orientation information, location information, and/or other position-related information associated with device 10 within a physical environment.

One or more depth sensor(s) 201 can be configured to measure the distance between sensors 201 and corresponding objects or surfaces within its field of view (FOV). Although depth sensors 201 are shown as being separate from motion and position sensors 200 in FIG. 4, depth sensors 201 can sometimes be considered part of sensors 200. The distance or depth information output by sensors depth 201 can provide information about the spatial layout of a physical environment, allowing for the creation of a 3D representation or depth map of the scene. Depth sensors 201 can compute depth information by projecting a pattern of light onto the scene and measuring corresponding distortions in the projected pattern of light in the scene, via time-of-flight (ToF) measurement techniques, by comparing visual information from two or more scene cameras with different perspectives, and/or using other depth sensing approaches. The example of FIG. 4 in which outward-facing cameras 204 and depth sensors 201 are shown as separate independent subsystems is illustrative. In some embodiments, one or more of cameras 204 can optionally be employed to obtain depth or distance information from the scene.

Motion and/or pose predictor 202 can receive the motion information, pose/orientation information, location information, and/or other position-related data output from sensors 200 and/or 201, including current motion/pose data and historical (past or recent) motion/pose data, to estimate or predict a future motion or pose of device 10 based on a linear or non-linear motion model. For example, predictor 202 can, based on the received sensor data, estimate or predict that device 10 will be moving in or towards a given direction in 3D space (e.g., that the user will be turning his/her head in a first direction or a second direction opposing the first direction about a yaw axis, tilting his/her head in a third direction or a fourth direction opposing the third direction about a roll axis orthogonal to the yaw axis, and/or arching his/her head in a fifth direction or a sixth direction opposing the fifth direction about a pitch axis orthogonal to the yaw axis and the roll axis).

The yaw, roll, and pitch of a user’s head, which represent three degrees of freedom (DoF), may collectively define a user’s “ head orientation.” The user’s head orientation along with a position of the user, which represent three additional degrees of freedom (e.g., X, Y, Z in a 3-dimensional space), can be collectively defined herein as the user’s “head pose.” The user’s head pose can therefore represent six degrees of freedom. The associated sensors 200 and 201 for estimating or predicting head pose may assume that device 10 is mounted on the user’s head. Therefore, references herein to head pose, head movement, yaw of the user’s head (e.g., rotation around a vertical axis), pitch of the user’s head (e.g., rotation around a side-to-side axis), roll of the user’s head (e.g., rotation around a front-to-back axis), etc. may be considered interchangeable with references to device pose, device movement, yaw of the device, pitch of the device, roll of the device, etc. In certain embodiments, sensors 200 may also include 6 degrees of freedom (DoF) tracking sensors, which can be used to monitor both rotational movement such as roll, pitch, and yaw and also positional/translational movement in a 3D environment.

Communications circuitry 206 may be used to support communications between device 10 and external equipment. Communications circuitry 206 may include antennas, radio-frequency (RF) transceiver circuitry, associated RF front-end circuitry, and other wireless communications circuitry and/or wired communications circuitry. Circuitry 206, which may sometimes be referred to as control circuitry and/or control and communications circuitry, may support bidirectional wireless communications between device 10 and external equipment (e.g., a companion device such as a computer, cellular telephone, or other electronic device, a wearable device such as a pair of earbuds, a wristwatch, a ring, or other wearable device, an accessory such as a point device or a controller, computer stylus, or other input device, speakers or other output devices, etc.) over a wireless link. Circuitry 206 of such type is thus sometimes referred to as wireless communications circuitry.

For example, communications circuitry 206 may include radio-frequency transceiver circuitry such as wireless local area network (WLAN) transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a wireless power coil and an associated rectifier configured to receive wireless power that is provided to power receiving circuitry in device 10.

In the example of FIG. 4, device 10 can be configured to communicate with one or more associated devices such as devices 10E-1 and 10E-2, device 10W, and/or other electronic devices. As shown in FIG. 4, all such devices 10, 10E-1, 10E-2, and 10W surrounded by dotted line 240 can be mounted on or worn by a user and can sometimes collectively be referred to as a system of devices. Each of these devices that are worn by the user can each include one or more scene-facing camera(s) for capturing a respective portion of the scene. At least some of the images captured by the various devices can contribute to the color correction of the AR content being presented on the see-through display of device 10. Device 10 can represent a head-mounted device of the type described in connection with FIGS. 1-3. Device 10E-1 may represent a first earbud that can be worn on or mounted within a first ear (e.g., a left ear) of the user and is thus sometimes referred to as a left earbud. Device 10E-2 may represent a second earbud that is worn on or mounted within a second ear (e.g., a right ear) of the user and is thus sometimes referred to as a right earbud. Devices 10E-1 and 10E-2 are thus sometimes referred to collectively as a pair of earbuds.

Each earbud 10E can include one or more speaker(s) 220 for outputting sound to the user’s ear, one or more camera(s) 222, communications circuitry 224, and/or other electronic components. Camera(s) 222 may represent one or more external-facing image sensors configured to capture a portion of the physical environment when mounted on the user’s ear. Communications circuitry 224 of device 10E may have similar structure and function to communications circuitry 206 described above in connection with device 10. In some embodiments, communications circuitry 224 of device 10E can be configured to communicate with communications circuitry 206 of device 10 using wireless signals 226 (e.g., devices 10E-1 and 10E-2 can be wirelessly paired with head-mounted device 10). In such scenarios, devices 10E-1 and 10E-2 can be referred to as wireless earbuds. In other embodiments, devices 10E-1 and 10E-2 can alternatively be implemented as wired earbuds.

Device 10W may represent a wristwatch or smartwatch that can be worn or otherwise attached (e.g., via a strap or bracelet) to the user’s wrist. Device 10W can be worn on the user’s left wrist or the user’s right wrist depending on the user’s preference. If desired, the user can wear a first device 10W on his left wrist and, at the same time, a second device 10W on his right wrist (e.g., the user can wear a smartwatch on both wrists). Device 10W can include at least one display 230, one or more camera(s) 232, communications circuitry 234, an optional color correction subsystem 235, and/or other electronic components. The watch display 230 can be configured to present time and date information, health and fitness related metrics, weather-related information, notifications, music controls, navigation information, one or more applications or widgets, and/or other selectable or non-selectable graphic user interface elements or features. Camera(s) 232 may represent one or more external-facing image sensors configured to capture a portion of the physical environment when attached to the user’s wrist. Communications circuitry 234 of device 10W may have similar structure and function to communications circuitry 206 described above in connection with device 10. In some embodiments, communications circuitry 234 of device 10W can be configured to communicate with communications circuitry 206 of device 10 using wireless signals 236 (e.g., device 10W can be wirelessly paired with head-mounted device 10). In some embodiments, color correction subsystem 235 in device 10W can be configured to perform color correction on images captured locally by camera(s) 232 prior to assisting device 10 with color correction of the AR content to be displayed.

In this context, the head-mounted device 10 can be preferred to as a “primary” device, whereas earbuds 10E-1 and 10E-2 and wristwatch 10W can be referred to as “secondary” or “accessory” devices that can assist with one or more functions of the primary device 10. Although the example of FIG. 4 shows only wireless earbuds and a wristwatch being paired with the primary head-mounted device 10, other types of secondary devices such as a smartphone, smart ring, smart wristband or armband, smart necklace or pendant, smart glove, smart belt, and/or other smart wearable device can be included as part of the overall system.

In certain embodiments, any one or more of the cameras within the system described in connection with FIG. 4 can include more than three color filters to capture multispectral data. For example, a camera can include, in addition to red, green, and blue color filters, a magenta color filter, a cyan color filter, and/or an infrared color filter. Such type of camera can capture multispectral data that is used to obtain a 3D reflectance map of the physical environment, which can include depth information from an associated depth sensor (see, e.g., depth sensor 201). Collecting multispectral data in this way can be technically advantageous and beneficial to achieve improved color correction of the AR content being presented on the see-through display of device 10.

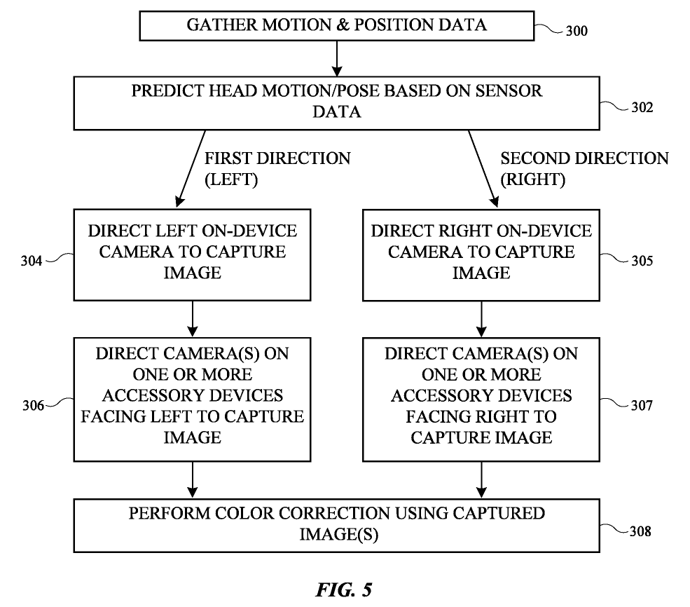

In accordance with some embodiments, one or more of secondary/accessory devices can be configured to capture images for facilitating color correction of AR content being presented on the see-through display of device 10. FIG. 5 is a flowchart of illustrative steps for operating electronic devices of the types shown in FIG. 4. During the operations of block 300, device 10 may be configured to gather motion and position data. For example, sensors 200 (e.g., VIO/SLAM subsystems) and/or depth sensor(s) 201 in device 10 can be configured to output motion information, pose/orientation information, location information, depth information, and/or other position-related information associated with device 10 within a physical environment.

During the operations of block 302, device 10 can be configured to estimate or predict a head motion or head pose based on the various sensor data acquired from block 300. For example, prediction subsystem 202 in device 10 can be configured to estimate or predict a particular direction towards which device 10 will be facing within the next second, within the next 500-1000 ms (millisecond), within the next 100-500 ms, or within the next 10-100 ms. In real-world scenarios, a user will tend to move his/her head from left to right or from right to left. Predictor 202 can predict or determine the direction (e.g., left or right) and the speed at which the user’s head is moving. Based on the predicted movement, the overall system of devices can capture one or more images with appropriate capture parameters to meet the latency of the color correction algorithm.

For example, if the predicted direction of the head pose is to the left (as shown by arrow 210 in FIG. 4), processing may proceed to block 304 to activate a first subset of cameras in the system. During the operations of block 304, leftward-facing camera 204-1 on device 10 can be activated to capture an image. The image capture by camera 204-1 can be triggered by a capture signal output from predictor 202 in response to determining that device 10 is turning left. During the operations of block 306, predictor 202 can similarly direct the cameras on one or more accessory devices facing to the left of the scene to capture images. In the example of FIG. 4, predictor 202 can send wireless trigger signals, via associated the wireless communications circuitry, to activate camera 222 on earbud 10E-1 worn on the user’s left ear and/or camera 232 on watch 10W worn on the user’s left wrist to capture images. These images captured by the secondary device(s) and any associated metadata can be wireless transmitted to primary device 10. For example, the metadata can include a color correction matrix, a degree of transparency, a chroma enhancement (boost) coefficient, and/or other color correction metadata. If desired, watch 10W can use color correction subsystem 235 to first locally color correct the image for the ambient lighting before transmitting the image to primary device 10.

Alternatively, if the predicted direction of the head pose is to the right (as shown by arrow 212 in FIG. 4), processing may proceed to block 305 to activate a second subset of cameras, different than the first subset of cameras, in the system. During the operations of block 305, rightward-facing camera 204-2 on device 10 can be activated to capture an image. The image capture by camera 204-2 can be triggered by a capture signal output from predictor 202 in response to determining that device 10 is turning right. During the operations of block 307, predictor 202 can similarly direct the cameras on one or more accessory devices facing to the right of the scene to capture images. In the example of FIG. 4, predictor 202 can send wireless trigger signals, via associated the wireless communications circuitry, to activate camera 222 on earbud 10E-2 worn on the user’s right ear and/or camera 232 on watch 10W (if worn on the user’s right wrist) to capture images. These images captured by the secondary device(s) and any associated metadata can be wireless transmitted to primary device 10.

The example described herein in which device 10 includes a leftward-facing camera 204-1 and a rightward-facing camera 204-2 is illustrative. In general, device 10 can include an upward-facing camera that is selectively triggered in response to detecting the user moving his/her head upwards, a downward-facing camera that is selectively triggered in response to detecting the user moving his/her head downwards, and/or additional camera(s) pointed in other direction(s) within the scene.

During the operations of block 308, device 10 can perform color correction based on the various images captured during the operations of block 304, 306, 305, and/or 307. For example, the color correction operations being performed by color correction subsystem 110 of FIG. 3 can be based on pixel data and metadata from not only images captured by the on-board cameras 204 but also images captured by the camera(s) within one or more external secondary/accessory devices. Using external secondary/accessory devices to proactively capture images (e.g., images than can include portions of the scene not necessarily within the field of view of on-board cameras in the primary device 10) to assist with color correction of the AR content being presented on the see-through display of device 10 can be technically advantageous and beneficial to reduce the latency of the color correction operations.

This example in which images from multiple devices are leveraged to improve color correction of AR content being displayed at primary device 10 is illustrative. If desired, images captured from multiple devices such as from earbuds, a wristwatch, and/or other accessory devices can be passed to primary device 10 to aid device 10 in performing better VIO/SLAM based localization. Improved localization accuracy would also, in turn, provide better color correction of AR content. If desired, device 10 may further include additional sensors such as an ambient light sensor, flicker sensor, proximity sensor, other light-based sensor, a GPS (global positioning system) component, and/or other satellite communications circuitry to enable more accurate localization.

The operations of FIG. 5 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

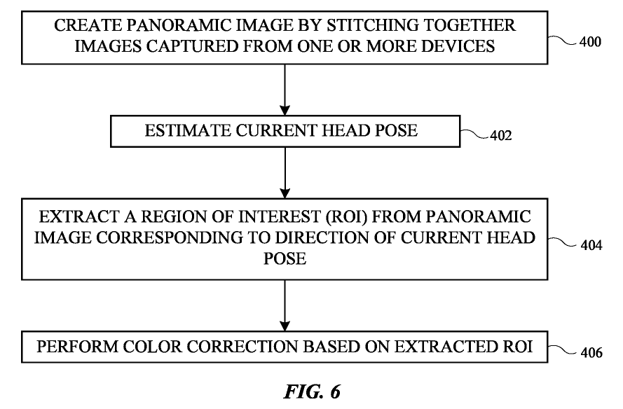

The embodiment of FIG. 5 in which color correction of AR content is performed based on images captured from the primary head-mounted device and/or images captured from one or more associated secondary/accessory devices is illustrative. In accordance with another embodiment, FIG. 6 shows a flowchart of illustrative steps for performing color correction of AR content based on a stitched panoramic image.

During the operations of block 400, device 10 can construct a panoramic image by stitching together images captured using one or more devices. For example, one or more scene-facing camera(s) 204 on device 10, one or more scene-facing camera(s) 222 on earbud devices 10E-1 and 10E-2, one or more scene-facing camera(s) 232 on wristwatch device 10W, and/or one or more scene-facing camera(s) on a smartphone or other secondary device(s) can be configured to capture a plurality of images corresponding to different portions of the scene, where at least some of the portions have at least partially overlapping regions. The plurality of images can be stitched together, by matching overlapping regions and aligning key features, to create a corresponding ultra-wide field of view image, sometimes referred to as a panoramic image. This example in which image sensors from primary device 10 and one or more associated secondary devices are stitched together to create a panoramic image is illustrative. As another example, images captured from different cameras on only primary head-mounted device 10 such images captured using depth sensor(s) 201, VIO/SLAM sensors 200, and/or cameras 204 can be combined to create a 3D panoramic image with accurate color of each object in the scene.

During the operations of block 402, device 10 may be configured to estimate a current head pose. For example, sensors 200 that are part of VIO/SLAM subsystems can be configured to determine or estimate the current head pose associated with device 10. If the background scene does not change (e.g., if there are no moving objects within the physical environment), the overall system may not capture a new image, but may instead use the panoramic image previously obtained from block 400 based on past image captures to perform color correction.

During the operations of block 404, device 10 may extract a region of interest (ROI) from the panoramic image, where the extracted ROI corresponds to the direction of the current estimated head pose. As an example, if the current head pose is pointed at a first direction, a first ROI of the panoramic image that is aligned to the first direction can be extracted. As another example, if the current head pose is pointed at a second direction, a second ROI of the panoramic image that is aligned to the second direction can be extracted.

During the operations of block 406, device 10 can then perform color correction of AR content based on the region of interest extracted from block 404. Various color correction algorithms described above in connection with FIG. 3 can be employed. For example, the first light superposition value, the second light superposition value, and the metadata for each pixel data being color corrected can be obtained from the extracted ROI. Performing color correction based on a previously constructed panoramic image without having to capture new images can be technically advantageous and beneficial to help reduce power consumption for the overall system. The color corrected AR content can then be displayed on the see-through display of device 10.

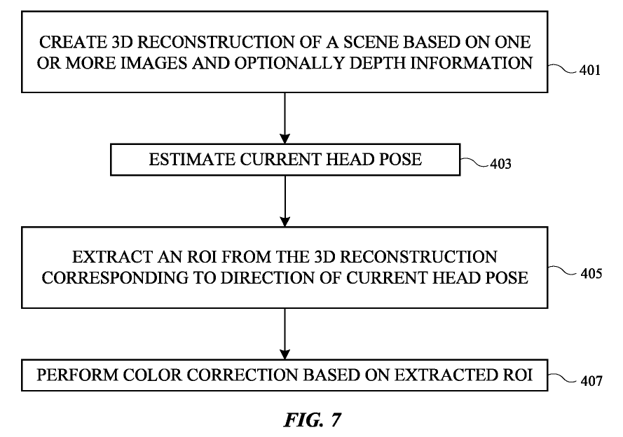

In accordance with another embodiment, FIG. 7 shows a flowchart of illustrative steps for performing color correction of AR content based on a three-dimensional (3D) reconstruction of a scene. Three-dimensional reconstruction can refer to a process of creating a digital 3D representation of a physical environment using sensors such as image sensors, depth sensors, and/or light detection and ranging (LiDAR) sensors, as examples.

During the operations of block 401, device 10 can create a 3D reconstruction of a scene based on one or more images captured using one or more devices and/or based on depth information obtained using depth sensor(s) 201 on device 10. For example, one or more scene-facing camera(s) 204 on device 10, one or more scene-facing camera(s) 222 on earbud devices 10E-1 and 10E-2, one or more scene-facing camera(s) 232 on wristwatch device 10W, and/or one or more scene-facing camera(s) on a smartphone or other secondary device(s) can be configured to capture a plurality of images corresponding to different portions of the scene, where at least some of the portions have at least partially overlapping regions. The plurality of images and the depth information can collectively be used to construct a 3D model of the physical scene. The 3D reconstruction of the scene can be referred to as a 3D scene model, a 3D scene representation, or a 3D scene reconstruction and can be represented using a 3D (textured) mesh, a depth map, a point cloud, or other data structures. If desired, other ways of performing 3D scene reconstruction, such as using photogrammetry or light detection and ranging (LiDAR) techniques, can also be employed.

During the operations of block 403, device 10 may be configured to estimate a current head pose. For example, sensors 200 that are part of VIO/SLAM subsystems can be configured to determine or estimate the current head pose associated with device 10. If the background scene does not change (e.g., if there are no moving objects within the physical environment), the overall system may not capture a new image, but may instead use the reconstructed 3D model of the scene previously obtained from block 401 based on past image captures to perform color correction.

During the operations of block 405, device 10 may extract a region of interest (ROI) from the 3D scene reconstruction, where the extracted ROI corresponds to the direction of the current estimated head pose. As an example, if the current head pose is pointed at a first direction, a first ROI of the 3D scene reconstruction that is aligned to the first direction can be extracted. As another example, if the current head pose is pointed at a second direction, a second ROI of the 3D scene reconstruction that is aligned to the second direction can be extracted.

During the operations of block 407, device 10 can then perform color correction of AR content based on the region of interest extracted from block 405. Various color correction algorithms described above in connection with FIG. 3 can be employed. For example, the first light superposition value, the second light superposition value, and the metadata for each pixel data being color corrected can be obtained from the extracted ROI. Performing color correction based on a previously constructed 3D scene model without having to capture new images can be technically advantageous and beneficial to help reduce power consumption for the overall system. The color corrected AR content can then be displayed on the see-through display of device 10.

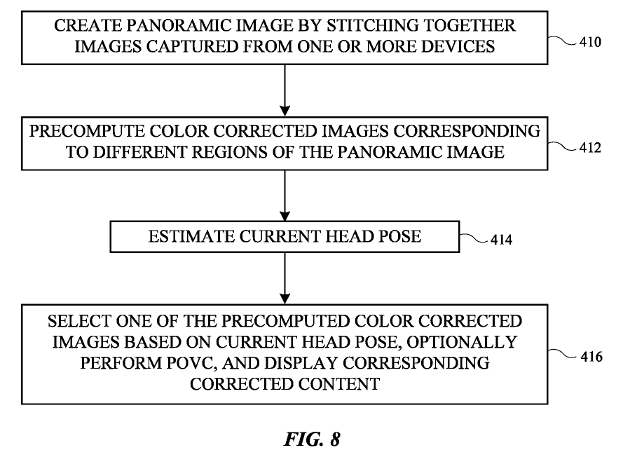

The examples of FIGS. 6-7 in which color correction is performed after extracting a region of interest from a panoramic image or a 3D reconstruction of a scene is illustrative. In accordance with another embodiment, FIG. 8 shows a flowchart of illustrative steps for precomputing a plurality of color corrected images. During the operations of block 410, device 10 can construct a panoramic image by stitching together images captured using one or more devices. For example, one or more scene-facing camera(s) 204 on device 10, one or more scene-facing camera(s) 222 on earbud devices 10E-1 and 10E-2, one or more scene-facing camera(s) 232 on wristwatch device 10W, and/or one or more scene-facing camera(s) on a smartphone or other secondary device(s) can be configured to capture a plurality of images corresponding to different portions of the scene, where at least some of the portions have at least partially overlapping regions. The plurality of images can be stitched together, by matching overlapping regions and aligning key features, to create a corresponding ultra-wide field of view image, sometimes referred to as a panoramic image. This example in which image sensors from primary device 10 and one or more associated secondary devices are stitched together to create a panoramic image is illustrative. As another example, images captured from different cameras on only primary head-mounted device 10 such images captured using depth sensor(s) 201, VIO/SLAM sensors 200, and/or cameras 204 can be combined to create a 3D panoramic image with accurate color of each object in the scene.

During the operations of block 412, device 10 may be configured to precompute a plurality of color corrected images corresponding to different regions of the panoramic image. Various color correction algorithms described above in connection with FIG. 3 can be employed for such precomputation. For example, device 10 may precompute a first color corrected image corresponding to AR content being placed at a first location or region of the panoramic image, a second color corrected image corresponding to the AR content being placed at a second location or region of the panoramic image, a third color corrected image corresponding to the AR content being placed at a third location or region of the panoramic image, and a fourth color corrected image corresponding to the AR content being placed at a fourth location or region of the panoramic image. This example in which four color corrected images corresponding to four different locations of the panoramic image are precomputed is illustrative. In general, device 10 may be configured to precompute two or more images corresponding to different locations in the panoramic image, three or more images corresponding to different locations in the panoramic image, four or more images corresponding to different locations in the panoramic image, five to ten images corresponding to different locations in the panoramic image, or more than ten images corresponding to different locations in the panoramic image. The precomputed images can be temporarily stored on memory of device 10.

During the operations of block 414, device 10 may be configured to estimate a current head pose. For example, sensors 200 that are part of VIO/SLAM subsystems can be configured to determine or estimate the current head pose associated with device 10. During the operations of block 416, device 10 may be configured to select one of the precomputed color corrected images based on the current head pose determined from block 414. For example, if the estimated head pose is pointed towards or is aligned to the first location of the panoramic image, the see-through display of device 10 can simply load (from memory) the first precomputed color corrected image. As another example, if the estimated head pose is pointed towards or is aligned to the second location of the panoramic image, the see-through display of device 10 can simply load (from memory) the second precomputed color corrected image. As another example, if the estimated head pose is pointed towards or is aligned to the third location of the panoramic image, the see-through display of device 10 can simply load (from memory) the third precomputed color corrected image. As another example, if the estimated head pose is pointed towards or is aligned to the fourth location of the panoramic image, the see-through display of device 10 can simply load (from memory) the fourth precomputed color corrected image.

If desired, point of view correction (POVC) can optionally be performed on the precomputed color corrected images being loaded for display (e.g., a perspective of the precomputed image being selected for display can be corrected based on the current head pose). Loading a selected one of a plurality of precomputed color corrected images without having to capture new images can be technically advantageous and beneficial to help reduce latency for optimal user experience. The color corrected AR content can then be displayed on the see-through display of device 10. The example of FIG. 8 in which multiple color corrected images can be precomputed based on a panoramic image is illustrative. In other embodiments, multiple color corrected images can be precomputed based on the 3D reconstruction of the scene.

The methods of FIGS. 6, 7, and/or 8 in which color corrected AR content is obtained based on a current head pose are exemplary. In other embodiments, the color corrected AR content can be generated based on a predicted head pose. “Current” head pose can refer to the user’s present head pose, whereas “predicted” head pose can refer to the user’s head pose at some forward-looking or future point in time. Head pose may be predicted using motion/pose prediction subsystem 202 of the type described in connection with FIG. 4.

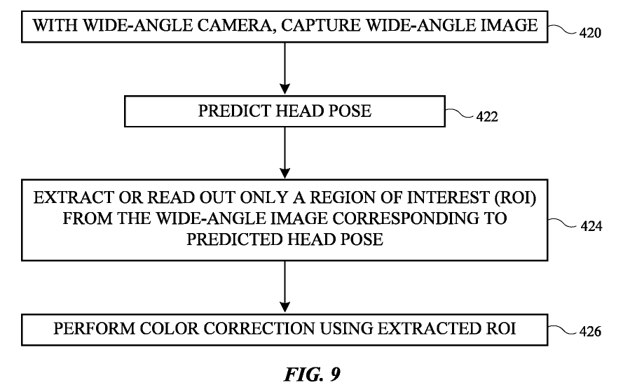

The embodiments of FIGS. 6 and 8 in which color correction is performed based on a stitched panoramic image are exemplary. FIG. 9 shows a flowchart of illustrative steps for performing color correction based on an image captured using only one wide-angle camera on the head-mounted device 10. During the operations of block 420, a single wide-angle camera on device 10 can be configured to capture a wide-angle image. The wide-angle camera can have a focal length that is less than 24 mm, less than 20 mm, less than 16 mm, or less than 10 mm. Such wide-angle camera is sometimes referred to as an ultra-wide-angle image sensor, a super-wide-angle image sensor, or a fisheye image sensor. Using a wide field of view camera can be technically advantageous to help obviate the need to stitch together images captured using multiple different cameras on device 10 and/or other associated accessory/secondary devices. The wide field of view camera can optionally include more than three color filters for capturing multispectral data that is used to create a 3-dimensional reflectance map of a physical environment in which device 10 is operated.

During the operations of block 422, device 10 may be configured to estimate or predict a head pose. For example, head pose may be predicted using motion/pose prediction subsystem 202 of the type described in connection with FIG. 4. Alternatively, sensors 200 that are part of VIO/SLAM subsystems can be configured to determine or estimate a current head pose associated with device 10. If the background scene does not change (e.g., if there are no moving objects within the physical environment), device 10 may not need to capture a new image, but may instead use the wide-angle image previously obtained from block 420 to perform color correction.

During the operations of block 424, device 10 may extract or read out only a region of interest (ROI) of the wide-angle image, where the ROI corresponds to the direction of the predicted head pose. Device 10 may be capable of reading out different ROIs from an image pixel array of the image sensor (e.g., by reading out only a subset of pixels in the pixel array). As an example, if the predicted head pose is pointed towards a first direction, a first ROI of the wide-angle image that is aligned to the first direction can be read out. As another example, if the predicted head pose is pointed towards a second direction, a second ROI of the wide-angle image that is aligned to the second direction can be read out. Additionally or alternatively, the image sensor of the wide-angle camera may only capture image data in a corresponding ROI of the entire pixel array depending on the predicted head pose. Performing partial image capture and/or readout in this way can be technically advantageous to reduce power consumption and also readout latency. If desired, pixel binning and bit depth can be chosen to optimize for more efficient or accurate color correction.

During the operations of block 426, device 10 can then perform color correction of AR content based on the region of interest read out during block 424. Various color correction algorithms described above in connection with FIG. 3 can be employed. For example, the first light superposition value, the second light superposition value, and the metadata for each pixel data being color corrected can be obtained from the ROI. Performing color correction based on a previously captured wide-angle image without having to capture new images can be technically advantageous and beneficial to help reduce power consumption for the overall system. The color corrected AR content can then be displayed on the see-through display of device 10.

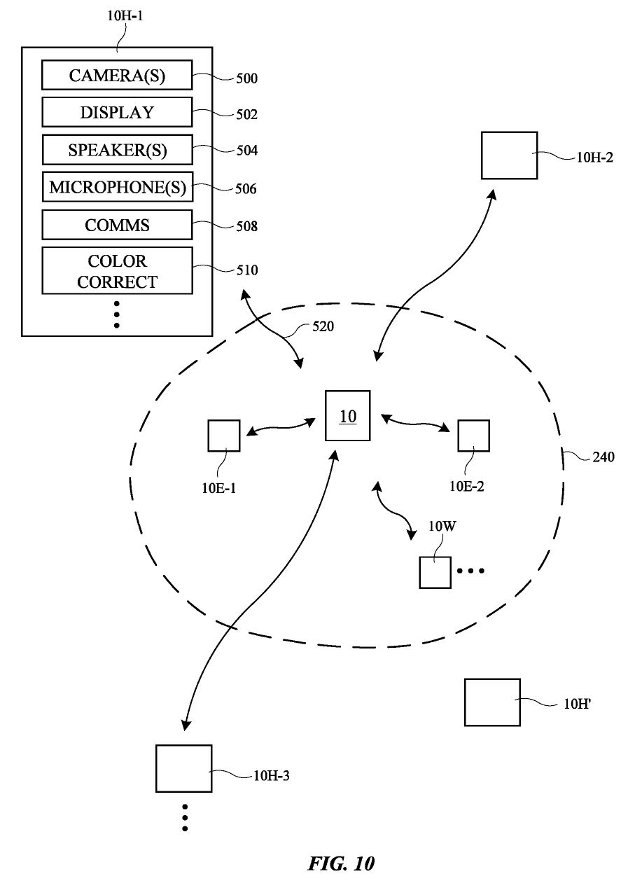

The embodiments described above in connection with FIGS. 4-8 in which cameras from multiple wearable devices can be used to assist with the color correction of AR content and/or localization operations for the primary head-mounted device 10 are illustrative. If desired, additional non-wearable devices within a controlled environment can also be used to capture images to further assist with the color correction and/or localization operations for the primary device 10. FIG. 10 is a diagram showing how device 10 may not only be paired with devices that are worn on a user (see, e.g., devices 10E-1, 10E-2, and 10W within dotted region 240) but can also be paired with additional external devices that are disposed within a controlled environment such as within the user’s home, office, or other private setting.

In the example of FIG. 10, primary device 10 can be wirelessly paired with one or more additional devices such as devices 10H-1, 10H-2, and/or 10H-3, sometimes referred to collectively as devices 10H. Devices 10H can represent a voice-controlled speaker device, a smart virtual assistant device, a smart lighting device, a smart plug, a smart thermostat or climate control device, a smart motion sensor, a smart air quality sensor, a smart home/office hub device for integrating features from different platforms or devices, wireless access points (e.g., Wi-Fi access point devices), other radio-frequency devices, and/or other types of smart home/office devices.

As shown in FIGS. 10,10H-1 can optionally include one or more camera(s) 500, display 502, one or more speaker(s) 504, one or more microphone(s) 506, communications circuitry 508, color correction subsystem 510, and/or other electronic components. If desired, device 10H-1 may further include additional sensors such as an ambient light sensor, flicker sensor, proximity sensor, and/or other light-based sensors. Camera(s) 500 may represent one or more scene-facing image sensors configured to capture a portion of the physical environment in which device 10 is currently operating. Display 502 can be configured to present time and date information, weather-related information, air quality information, notifications, music controls, lighting controls, power controls, one or more applications or widgets, and/or other selectable or non-selectable graphic user interface elements or features. Speaker(s) 504 may be configured to output audio information to the user. Microphone(s) 506 can be configured to sense audio signals within the physical environment.

Communications circuitry 508 of device 10H-1 may have similar structure and function to communications circuitry 206 described above in connection with device 10. In some embodiments, communications circuitry 508 of device 10H-1 can be configured to communicate with communications circuitry 206 of device 10 using wireless signals 520 (e.g., device 10H-1 can be wirelessly paired with head-mounted device 10). In some embodiments, color correction subsystem 510 in device 10H-1 can be configured to perform color correction on images captured locally by camera(s) 500 prior to assisting device 10 with color correction of the AR content to be displayed (e.g., device 10H-1 can use color correction subsystem 510 to first locally color correct the image for the ambient lighting before transmitting the image to primary device 10). In this context, devices 10H such as device 10H-1 can also be referred to as “secondary” devices for assisting with one or more functions of the primary device 10. Devices 10H are not typically worn by the user and are thus sometimes referred to as a “non-wearable” devices.

The other secondary devices such as device 10H-2 and/or 10H-3 can have similar features, more features, or fewer features than device 10H-1. The example of FIG. 10 in which device 10 is paired with three non-wearable devices 10H is illustrative. In general, device 10 can be wirelessly pair with one or more non-wearable device, two or more non-wearable devices, three or more non-wearable devices, four or more non-wearable devices, five to ten non-wearable devices, or more than ten non-wearable devices, at least some of which can include cameras for capturing images for facilitating color correction of AR content and/or localization operations for the primary head-mounted device 10 or other mobile device (e.g., a smartphone) on the user. At least some of devices 10H may be associated with the user. In other embodiments, at least some of the devices 10H’ within the environment can optionally with associated with another user different than the user of primary device 10. In such scenarios, image or location data gathered by device(s) 10H’ associated with the other user can also be shared with device 10 for localization or color correction purposes.

The foregoing is merely illustrative and various modifications can be made to the described embodiments. The foregoing embodiments may be implemented individually or in any combination.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

What is claimed is:

1. A method of operating a head-mounted device, comprising:
gathering sensor data;
predicting a pose of the head-mounted device based on the gathered sensor data;
in response to determining that the predicted pose of the head-mounted device is facing a first direction, directing a first device external to the head-mounted device to capture a first image; and
in response to determining that the predicted pose of the head-mounted device is facing a second direction different than the first direction, directing a second device external to the head-mounted device to capture a second image.

2. The method of claim 1, wherein:
the first device comprises a left earbud device having one or more cameras configured to capture the first image; and
the second device comprises a right earbud device having one or more cameras configured to capture the second image.

3. The method of claim 1, wherein the second device comprises a wristwatch device having one or more cameras configured to capture the second image.

4. The method of claim 1, further comprising:
wirelessly receiving the first image from the first device;
color correcting augmented reality (AR) content based on the first image wirelessly received from the first device to produce corresponding color corrected content; and
presenting, on a transparent display of the head-mounted device, the color corrected content.

5. The method of claim 4, further comprising:
wirelessly receiving metadata from the first device, wherein the metadata includes one or more of a color correction matrix, a degree of transparency, and a chroma enhancement coefficient associated with the first image.

6. The method of claim 1, further comprising:
wirelessly receiving the first image from the first device; and
determining a location of the head-mounted device based on the first image wirelessly received from the first device.

7. The method of claim 1, wherein:
the first device comprises one or more first cameras;
the second device comprises one or more second cameras;
the head-mounted device comprises one or more third cameras; and
at least some of the first, second, and third cameras includes more than three color filters for capturing multispectral data that is used to create a 3-dimensional reflectance map of a physical environment in which the head-mounted device is operated.

8. The method of claim 1, further comprising:
in response to determining that the predicted pose of the head-mounted device is facing the first direction, directing a first image sensor in the head-mounted device to capture a third image; and
in response to determining that the predicted pose of the head-mounted device is facing the second direction, directing a second image sensor in the head-mounted device to capture a fourth image.

9. The method of claim 1, further comprising:
wirelessly receiving an image from a non-wearable device external to the head-mounted device and different than the first and second devices; and
color correcting augmented reality (AR) content based on the image wirelessly received from the non-wearable device to produce corresponding color corrected content.

10. The method of claim 1, further comprising:
wirelessly receiving an image from a non-wearable device external to the head-mounted device and different than the first and second devices; and
determining a location of the head-mounted device based on the image wirelessly received from the non-wearable device.

11. A method of operating a head-mounted device, comprising:
acquiring a plurality of images of a scene;
obtaining a panoramic image by stitching together the plurality of images or constructing a three-dimensional model of the scene based on the plurality of images;
estimating or predicting a pose of the head-mounted device;
color correcting augment reality (AR) content based on the panoramic image or the three-dimensional model of the scene and based on the pose of the head-mounted device to produce corresponding color corrected content; and
presenting, on a transparent display of the head-mounted device, the color corrected content.

12. The method of claim 11, further comprising:
extracting a region of interest from the panoramic image or from the three-dimensional model of the scene based on the estimated or predicted pose of the head-mounted device, wherein color correcting the AR content comprises color correcting the AR content based on the extracted region of interest.

13. The method of claim 11, further comprising:
computing a plurality of color corrected images corresponding to different portions of the panoramic image, wherein color correcting the AR content comprises color correcting the AR content based on a selected one of the plurality of color correct images corresponding to the estimated or predicted pose of the head-mounted device.

14. The method of claim 11, wherein acquiring the plurality of images comprises:
with a plurality of cameras in the head-mounted device, acquiring the plurality of images.

15. The method of claim 11, wherein acquiring the plurality of images comprises:
wirelessly receiving at least some of the plurality of images from one or more devices external to the head-mounted device.

16. The method of claim 15, wherein the one or more devices comprises wearable devices selected from the group consisting of: wireless earbuds and a wristwatch.

17. The method of claim 15, wherein the one or more devices comprises a non-wearable device.

18. A method of operating a head-mounted device, comprising:
with a camera, capturing an image;
predicting a pose of the head-mounted device;
reading out or extracting only a subset of the image based on the predicted pose of the head-mounted device;
color correcting augment reality (AR) content based on the subset of the image to produce corresponding color corrected content; and
presenting, on a transparent display of the head-mounted device, the color corrected content.

19. The method of claim 18, wherein the camera comprises more than three color filters for capturing multispectral data that is used to create a 3-dimensional reflectance map of a physical environment in which the head-mounted device is operated.

20. The method of claim 18, wherein the head-mounted device is associated with a first user, the method further comprising:
wirelessly receiving an image from an external device that is associated with a second user different than the first user; and
determining a location of the head-mounted device based on the image wirelessly received from the external device.
